(19) United States
(12) Patent Application Publication
(10) Pub. No.: US 2015/0363188 A1
(43) Pub. Date: Dec. 17, 2015

(54) Information Processing Device and Information Processing System

(71) Applicant: Sony Computer Entertainment Inc., Tokyo (JP)

(72) Inventor: Akitsugu Tsuchiya, Kanagawa (JP)

(21) Appl. No.: 14/721,520

(22) Filed: May 26, 2015

(30) Foreign Application Priority Data
Jun. 11, 2014 (JP) 2014-120815

(51) Int. Cl. G06F 9/445

(52) U.S. Cl. CPC G06F 8/65

(57) ABSTRACT

An information processing device includes: a notification processing unit notifying a user that a terminal device is in a state of being able to update software; a confirmation receiving part receiving a confirmation that an update is to be performed from the user; and a transmitting section transmitting an execution instruction to update the software.

### BACKGROUND

The present technology relates to an information processing technology for updating software.

A technology in related art is known which sets a timer and automatically downloads software by a timer start at a set time. Japanese Patent Laid-Open No. 2012-3329 (hereinafter referred to as Patent Document 1), for example, discloses a technology in which an automatic download function is started at a set time to automatically access a file providing server and automatically download system software, a patch file of a game, or a content file of demonstration game software, a game trailer (game video), or the like.

### SUMMARY

Patent Document 1 discloses, when system software is automatically downloaded, not automatically updating to the downloaded system software unless a user agrees. Software generally includes an end-user license agreement (EULA) defining terms and the like to be observed by the user in using the software. The user can obtain a right (license) to use the software by agreeing to the EULA. Therefore, when system software is downloaded, it is generally necessary to perform an update after the user agrees, as disclosed in Patent Document 1.

In a case where the system software of an information processing device is automatically downloaded, when the user starts the information processing device, a EULA is first displayed on a screen, and the user agrees to the contents of the EULA, whereby a system update is started. After the system update is completed, the information processing device is restarted by the updated system software. Therefore, a user who wants to use the information processing device immediately may feel impatient at waiting during the time of the system update and the system restart-up.

It is accordingly desirable to realize an environment in which software can be updated efficiently.

A mode of the present technology relates to an information processing system including a first information processing device and a second information processing device. The first information processing device includes a download processing unit downloading software from a software server and an update processing unit updating software. The second information processing device includes a notification processing unit notifying a user that the first information processing device is in a state of being able to update the software, a confirmation receiving part receiving a confirmation that an update is to be performed from the user, and a transmitting section transmitting an execution instruction to update the software. When the update processing unit obtains the execution instruction to update the software, the update processing unit updates the software.

Another mode of the present technology is an information processing device. The information processing device includes: a notification processing unit notifying a user that a terminal device is in a state of being able to update software; a confirmation receiving part receiving a confirmation that an update is to be performed from the user; and a transmitting section transmitting an execution instruction to update the software.

Yet another mode of the present technology is an information processing device. This device includes: a download processing unit downloading software from a software server; a determining unit referring to predetermined data included in the downloaded software, and determining whether or not user confirmation of a software update is necessary; and an update processing unit transmitting information indicating that software is in an updatable state when the determining unit determines that the user confirmation is necessary; when the update processing unit obtains an execution instruction to update the software, the execution instruction being input by a user on a terminal device, the update processing unit updating the software.

Arbitrary combinations of the above constituent elements as well as modes obtained by converting expressions of the present technology between a method, a device, a system, a recording medium, a computer program, and the like are also effective as modes of the present technology.

According to the information processing technology according to an embodiment of the present technology, it is possible to realize an environment in which software can be updated efficiently.

### BRIEF DESCRIPTION OF THE DRAWINGS

FIG. 1 is a diagram showing an information processing system according to an embodiment of the present technology;

FIG. 2 is a functional block diagram of an information processing device;

FIG. 3 is a diagram showing a configuration of a first information processing device;

FIG. 4 is a diagram showing a configuration of a second information processing device;

FIG. 5 is a diagram showing a configuration of a notifying server; and

FIGS. 6A and 6B are diagrams showing an example of confirmation screens.

### DETAILED DESCRIPTION OF THE PREFERRED EMBODIMENT

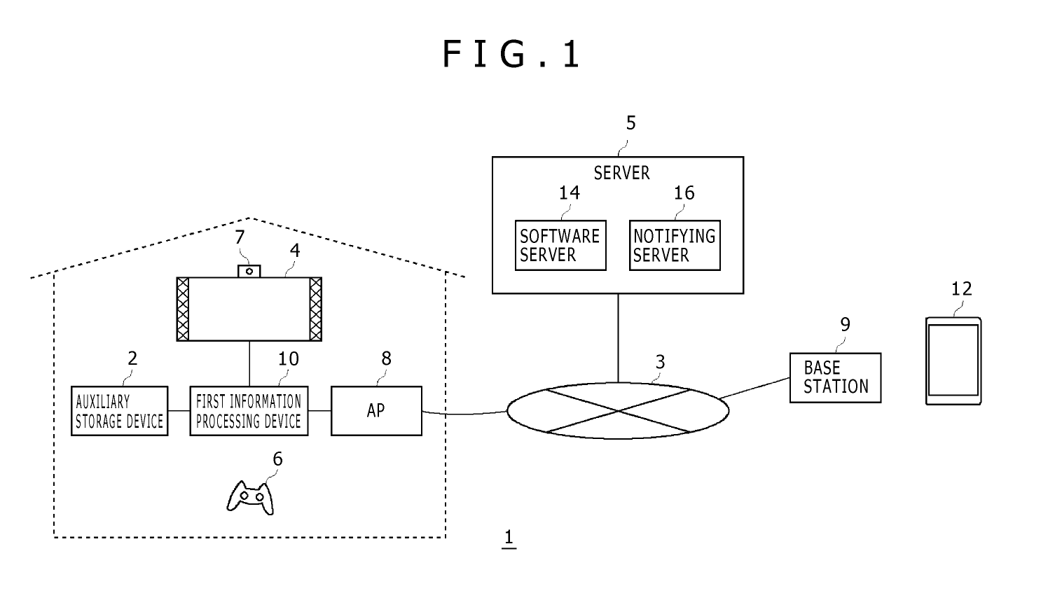

FIG. 1 shows an information processing system 1 according to an embodiment of the present technology. The information processing system 1 includes a first information processing device 10 and a second information processing device 12 as user terminals, and a server 5. The first information processing device 10 in the present embodiment may be a stationary terminal device, for example a game device, that is connected to a television set at home. The second information processing device 12 may be a portable terminal device such as a mobile telephone, a smart phone, a tablet, or the like. The first information processing device 10 and the second information processing device 12 are possessed by a same user. The user can carry the portable second information processing device 12 and operate the second information processing device 12 at any time even while the user is away from home.

An auxiliary storage device 2 is a mass storage device such as an HDD (Hard Disk Drive), a flash memory, or the like. The auxiliary storage device 2 may be an external storage device connected to the first information processing device 10 by a USB (Universal Serial Bus) or the like, or may be an internal storage device. An output device 4 may be a television set including a display for outputting an image and a speaker for outputting sound. The first information processing device 10 is connected to an input device 6 operated by the user by radio or by wire. The input device 6 outputs operation information indicating a result of operation by the user to the first information processing device 10. When the first information processing device 10 receives the operation information from the input device 6, the first information processing device 10 reflects the operation information in the processing of system software or an application, and makes a result of the processing output from the output device 4.

A camera 7 as an imaging device is provided in the vicinity of the output device 4. The camera 7 images a space around the output device 4. FIG. 1 shows an example in which the camera 7 is attached to an upper portion of the output device 4. However, the camera 7 may be disposed on a side of the output device 4. In either case, the camera 7 is disposed in such a position as to be able to image the user playing a game in front of the output device 4. Incidentally, the camera 7 may be a stereo camera.

In the present embodiment, the first information processing device 10 may be a game device that executes a game program, and the input device 6 may be a game controller that provides user operation information to the game device. The game controller includes a plurality of input portions such as a plurality of push type operating buttons, an analog stick allowing an analog quantity to be input, a rotary button, and the like.

An access point (hereinafter referred to as an “AP”) 8 has functions of a wireless access point and a router. The first information processing device 10 is connected to the AP 8 via radio or a wire to be communicatably connected to the server 5 on a network 3.

The server 5 provides network service to the user of the information processing system 1. The server 5 may be physically formed by a plurality of servers, and the servers may be maintained and managed by entities corresponding to the respective functions of the servers. The server 5 includes a network server not shown in the figures. As will be described later, the user is kept in a state of being signed in to this network server at all times, so that the user is provided with various kinds of service by the server 5. Incidentally, while the server 5 in the present example includes a software server 14 and a notifying server 16, each of the software server 14 and the notifying server 16 may be formed by a plurality of servers.

The software server 14 provides system software for constructing the usage environment of the first information processing device 10. The system software manages and controls the hardware of a computer. The system software includes an OS (operating system), and also includes middleware for extending the basic functions of the OS, and the like. The software server 14 retains a latest version of the system software, and provides the latest version of the system software to the first information processing device 10. The system software provided from the software server 14 includes a EULA (End-User License Agreement). When the EULA and a EULA of the system software currently incorporated in the first information processing device 10 are different from each other, the first information processing device 10 obtains an agreement of the user in regard to an update after downloading the latest version of the system software.

The notifying server 16 is a relay server for relaying information between the first information processing device 10 and the second information processing device 12. Specifically, when the first information processing device 10 has downloaded the latest version of the system software, the notifying server 16 receives information indicating that the system software is in an updatable state from the first information processing device 10, and notifies, by push notification, information indicating that the first information processing device 10 is in a state of being able to update the system software to the second information processing device 12. In this case, when the second information processing device 12 is a terminal device using a mobile telephone line, such as a smart phone or the like, the notification from the notifying server 16 is transmitted to the second information processing device 12 via a base station 9.

The second information processing device 12 notifies the user that the first information processing device 10 is in a state of being able to update the system software. When the user starts an updating application installed on the second information processing device 12, the screen of the second information processing device 12 displays an option for performing an update now. When the user selects the option, a EULA is displayed. When the contents of the EULA are accepted, the second information processing device 12 transmits an instruction to perform the update to the notifying server 16. Receiving the instruction to perform the update, the notifying server 16 notifies the instruction to perform the update to the first information processing device 10 by push notification. Receiving this notification, the first information processing device 10 performs an automatic update to the latest version of the system software.

An example of a mode of use of the information processing system 1 will be illustrated. The user sets a time of execution of an automatic download function of the first information processing device 10. Suppose that the set time of a timer is during the working hours of the user, for example noon. When noon arrives, the first information processing device 10 accesses the software server 14. When there is system software to which to perform an update, the first information processing device 10 automatically downloads the system software. The first information processing device 10 notifies the second information processing device 12 of the automatic download via the notifying server 16. The user checks the information using the second information processing device 12 at a place away from home. The user can be thus informed at the place away from home that the first information processing device 10 at home has downloaded the latest version of the system software to which latest version an update can be performed.

Viewing the notification, the user starts the updating application for giving an instruction for an update on the second information processing device 12. When the user chooses to perform an update now and accepts the contents of the EULA in the updating application, the second information processing device 12 transmits an instruction to perform an update to the first information processing device 10 via the notifying server 16. The first information processing device 10 thereby performs processing of updating the system software. The user can thus input an instruction to perform an update to the first information processing device 10 while the user is away from home. Therefore, when the user has returned home, the updating processing has already been completed, so that the user can start the first information processing device 10 by the latest system software, and play a game immediately.

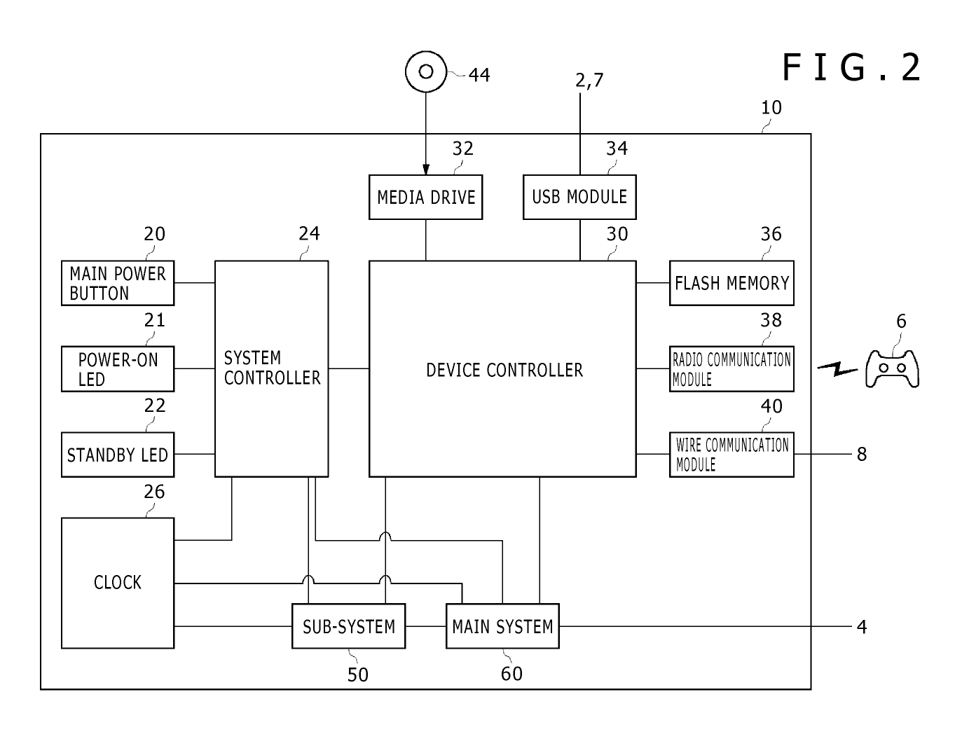

FIG. 2 is a functional block diagram of the first information processing device 10. The first information processing device 10 includes a main power button 20, a power-on LED (Light Emitting Diode) 21, a standby LED 22, a system controller 24, a clock 26, a device controller 30, a media drive 32, a USB module 34, a flash memory 36, a wireless communication module 38, a wire communication module 40, a subsystem 50, and a main system 60.

The main system 60 includes a main CPU (Central Processing Unit), a memory as a main storage device and a memory controller, a GPU (Graphics Processing Unit), and the like. The GPU is used mainly for arithmetic processing of a game program. These functions may be configured as a system on chip, and formed on one chip. The main CPU has a function of executing a game program recorded in the auxiliary storage device 2.

The subsystem 50 includes a sub-CPU, a memory as a main storage device and a memory controller, and the like. The subsystem 50 does not include a GPU, and does not have a function of executing a game program. The number of circuit gates of the sub-CPU is smaller than the number of circuit gates of the main CPU. The power consumption in operation of the sub-CPU is lower than the power consumption in operation of the main CPU. The sub-CPU operates while the main CPU is in a standby state. The processing functions of the sub-CPU are limited to reduce the power consumption of the sub-CPU.

The main power button 20 is an input section to which an operating input from the user is performed. The main power button 20 is provided to a front surface of a casing of the first information processing device 10. The main power button 20 is operated to turn on or off the supply of power to the main system 60 of the first information processing device 10. The power-on LED 21 is lit when the main power button 20 is turned on. The standby LED 22 is lit when the main power button 20 is turned off.

The system controller 24 detects the depression of the main power button 20 by the user. When the main power button 20 is depressed while a main power supply is in an off state, the system controller 24 obtains the depressing operation as a “turn-on instruction.” When the main power button 20 is depressed while the main power supply is in an on state, on the other hand, the system controller 24 obtains the depressing operation as a “turn-off instruction.”

The clock 26 is a real-time clock. The clock 26 generates present date and time information, and supplies the present date and time information to the system controller 24, the subsystem 50, and the main system 60. The automatic download function of the present embodiment is started when the date and time information provided from the clock 26 becomes the set time of the timer. In the automatic download function, whether the software server 14 has system software to be downloaded is checked first. The subsystem 50 is in charge of this checking function. When the presence of system software to be downloaded is confirmed, the subsystem 50 starts the main system 60. The main system 60 downloads the system software.

The device controller 30 is configured as an LSI (Large-Scale Integrated Circuit) that transfers information between devices like a Southbridge. As shown in FIG. 2, the device controller 30 is connected with devices such as the system controller 24, the media drive 32, the USB module 34, the flash memory 36, the wireless communication module 38, the wire communication module 40, the subsystem 50, the main system 60, and the like. The device controller 30 accommodates differences between electrical characteristics of the respective devices and differences between data transfer rates, and controls data transfer timing.

The media drive 32 is a drive device that is loaded with and drives a ROM medium 44 on which application software such as a game or the like and license information are recorded, and which drive device reads a program, data, and the like from the ROM medium 44. The ROM medium 44 is a read-only recording medium such as an optical disk, a magneto-optical disk, a Blu-ray disk, or the like.

The USB module 34 is a module connected to an external device by a USB cable. The USB module 34 may be connected to the auxiliary storage device 2 and the camera 7 by a USB cable. The flash memory 36 is an auxiliary storage device forming an internal storage. The wireless communication module 38 performs wireless communication with the input device 6, for example, under a communication protocol such as a Bluetooth (registered trademark) protocol, an IEEE 802.11 protocol, or the like. Incidentally, the wireless communication module 38 may support a third-generation (3rd Generation) digital mobile telephone system compliant with an IMT-2000 (International Mobile Telecommunication 2000) standard defined by the ITU (International Telecommunication Union), or may further support a digital mobile telephone system of another generation. The wire communication module 40 performs wire communication with an external device. The wire communication module 40 is connected to the external network via the AP 8, for example.

The configurations of the first information processing device 10, the second information processing device 12, and the notifying server 16 will be illustrated in the following.

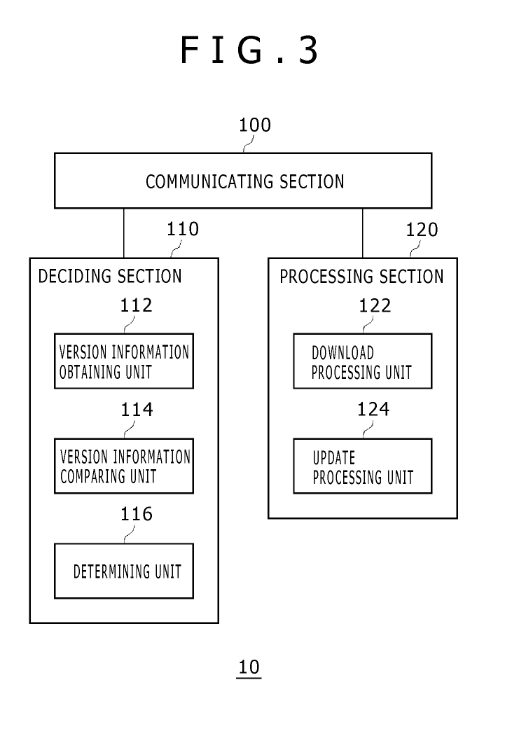

FIG. 3 shows the configuration of the first information processing device 10. The first information processing device 10 includes a communicating section 100, a deciding section 110, and a processing section 120. The deciding section 110 includes a version information obtaining unit 112, a version information comparing unit 114, and a determining unit 116. The processing section 120 includes a download processing unit 122 and an update processing unit 124. Incidentally, the communicating section 100 represents the functions of the radio communication module 38 and the wire communication module 40 shown in FIG. 2.

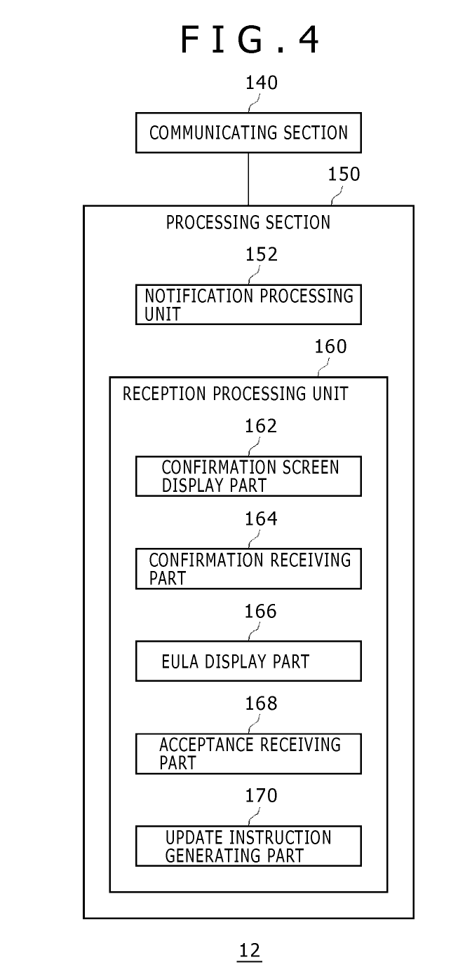

FIG. 4 shows the configuration of the second information processing device 12. The second information processing device 12 includes a communicating section 140 and a processing section 150. The processing section 150 includes a notification processing unit 152 and a reception processing unit 160. The reception processing unit 160 includes a confirmation screen display part 162, a confirmation receiving part 164, a EULA display part 166, an acceptance receiving part 168, and an update instruction generating part 170. Incidentally, while the communicating section 140 in the present embodiment is configured as a radio communication module that communicates with the base station 9 via a mobile telephone line, the communicating section 140 may have a wireless LAN communicating function. In addition, it is assumed that the second information processing device 12 in the present embodiment is a portable terminal device. However, the second information processing device 12 may be a stationary terminal device, for example a desktop computer used at work. In this case, the communicating section 140 may be connected to the network 3 by wire.

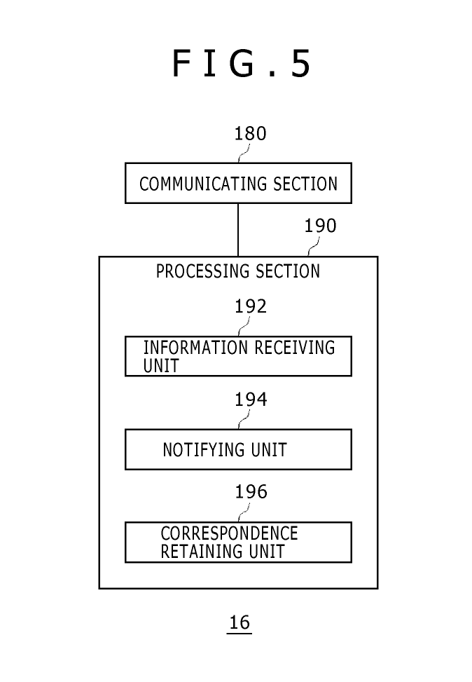

FIG. 5 shows the configuration of the notifying server 16. The notifying server 16 includes a communicating section 180 and a processing section 190. The processing section 190 includes an information receiving unit 192, a notifying unit 194, and a correspondence retaining unit 196.

The elements described as functional blocks performing various processing in FIGS. 3 to 5 can be configured by a circuit block, a memory, or another LSI in terms of hardware, and is implemented by a program loaded in a memory or the like in terms of software. Hence, it is to be understood by those skilled in the art that these functional blocks can be implemented in various forms by only hardware, only software, or combinations of hardware and software, and are not limited to any one of the forms.

In the information processing system 1 according to the present embodiment, the user is signed in to the network server at all times. As already described, the first information processing device 10 includes the main system 60 and the subsystem 50. The subsystem 50 is in an active state even while the main system 60 is in a standby state. Therefore, even when the main power supply of the first information processing device 10 is off, the subsystem 50 maintains connection to the network server, so that the signed-in state of the user is maintained. The first information processing device 10 can thereby access the server 5 even when the main power supply is off.

Referring to FIG. 3, the first information processing device 10 has an automatic download function activated at the time set in the timer. In the automatic download function, the version information obtaining unit 112 obtains the version information of the latest system software from the software server 14. The version information of the installed system software is recorded in the auxiliary storage device 2. The version information comparing unit 114 compares the version information obtained by the version information obtaining unit 112 with the version information of the installed system software. Incidentally, the version information obtaining unit 112 and the version information comparing unit 114 are implemented as functions in the subsystem 50, and perform the above-described processing in the state in which the main power supply of the first information processing device 10 is off.

When the version information comparing unit 114 determines that the version of the system software retained on the software server 14 is newer, the main system 60 is started to enable the functions of the processing section 120 to be performed. The version information comparing unit 114 supplies the download processing unit 122 with a system software download request. Thereby the download processing unit 122 automatically downloads the latest version of the system software from the software server 14. Here, the latest system software usually includes a correction file, an update file, a function adding file, or the like for the installed system software. Incidentally, the download processing unit 122 may download system software to be completely replaced with the installed system software, that is, system software for upgrade.

The determining unit 116 refers to predetermined data included in the downloaded system software or conditions at the time of the download, and determines whether or not the user confirmation of a software update is necessary. The predetermined data included in the system software in this case is data related to a EULA. The determining unit 116 determines whether the EULA accompanying the newly downloaded system software is updated from the EULA accompanying the installed system software. When version information is added to the EULAs, the determining unit 116 may determine whether or not the EULA is updated by comparing the pieces of version information of the EULAs to each other. When the EULA is updated, that is, the EULA included in the downloaded system software is different from the EULA included in the system software before the update (installed system software), the updated EULA needs to be checked by the user. The determining unit 116 therefore determines that the user confirmation of the software update is necessary.

In addition, the determining unit 116 determines whether application software is operating on the first information processing device 10 as the conditions at the time of the download by the download processing unit 122. When the system software is updated while application software is operating, the operation of the application software is forcibly terminated. The determining unit 116 therefore determines that the user confirmation of the software update is necessary when there is application software in operation.

When the determining unit 116 determines that the EULA included in the downloaded system software is not updated and determines that there is no application software in operation, and the determining unit 116 thus determines that user confirmation is not necessary for updating the system software, the update processing unit 124 automatically updates the system software. The automatic update in this case means that the update processing unit 124 updates the system software without confirmation by the user. The system software is therefore updated to the latest state without the user being aware of the update.

On the other hand, when the determining unit 116 determines that the EULA included in the downloaded system software is updated or determines that there is application software in operation, and the determining unit 116 thus determines that user confirmation is necessary for updating the system software, the update processing unit 124 transmits information indicating that the system software is in an updatable state from the communicating section 100. A destination to which the information is transmitted in the present embodiment is the notifying server 16 operating as a relay server that relays information. However, the update processing unit 124 may specify the address of the second information processing device 12, so that the information is directly transmitted to the second information processing device 12.

Referring to FIG. 5, the notifying server 16 includes the information receiving unit 192 receiving information through the communicating section 180 via the network 3 and the notifying unit 194 notifying information through the communicating section 180 via the network 3. The correspondence retaining unit 196 retains correspondence relations between information transmission sources and information notification destinations. The correspondence retaining unit 196 in the present example retains a relation in which the second information processing device 12 is an information notification destination when the first information processing device 10 is an information transmission source and a relation in which the first information processing device 10 is an information notification destination when the second information processing device 12 is an information transmission source.

When the information receiving unit 192 receives the information indicating that the system software is in an updatable state from the first information processing device 10, the notifying unit 194 notifies the second information processing device 12 of the information indicating that the system software is in an updatable state. When the information receiving unit 192 receives the information from the first information processing device 10, the notifying unit 194 may refer to the correspondence relations retained in the correspondence retaining unit 196, and immediately notify the information to the second information processing device 12 by push notification. Incidentally, when the second information processing device 12 is a portable device used in mobile telephone service, such as a mobile telephone, a smart phone, or the like, there is already a push server that performs push notification to portable devices within the service. Therefore, the notifying unit 194 may transmit the information indicating that the system software is in an updatable state to the push server together with the device ID of the second information processing device 12, and the push server may notify the information indicating that the system software is in an updatable state to the second information processing device 12 via the base station 9 by push notification on the basis of the device ID.

Referring to FIG. 4, in the second information processing device 12, the notification processing unit 152 obtains the information indicating that the first information processing device 10 is in a state of being able to update the system software via the communicating section 140, and notifies the information to the user. The contents of the notification may be for example “preparation for updating the system software has been made.” Viewing the contents of the notification, the user can be informed that the latest system software has been downloaded to the first information processing device 10. When the user starts the updating application installed on the second information processing device 12 after viewing the contents of the notification, each function in the reception processing unit 160 becomes executable.

After the updating application is started, the confirmation screen display part 162 first displays a confirmation screen for updating the system software on the display of the second information processing device 12.

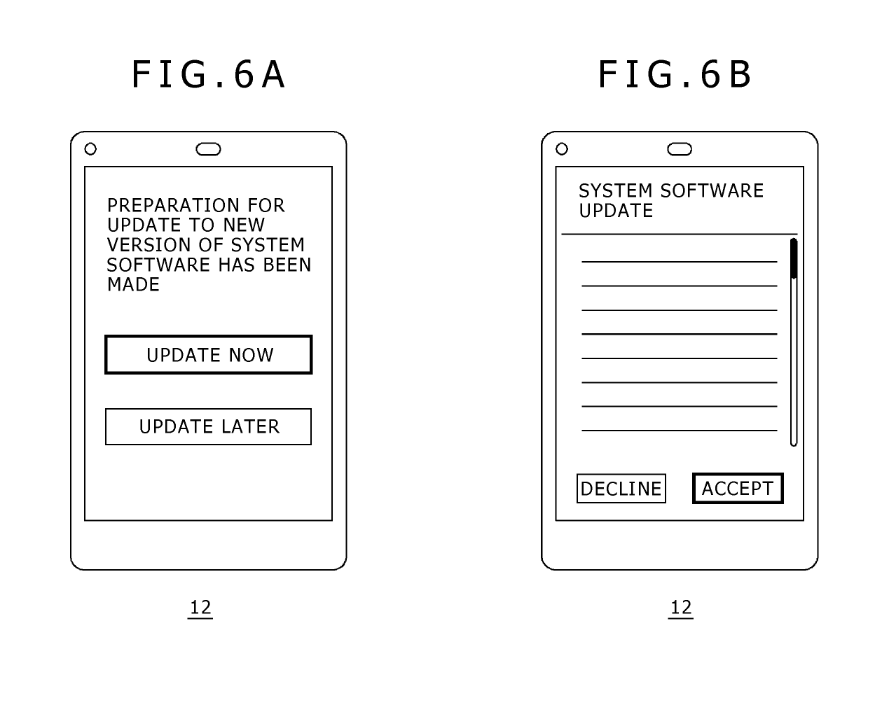

FIG. 6A shows an example of the update confirmation screen. The update confirmation screen provides a notification that the latest system software has been downloaded to the first information processing device 10 and is in a state of allowing an update, and presents options to “update now” or “update later” to the user. When the display of the second information processing device 12 is formed as a touch panel, the user can choose whether or not to perform the update by tapping one of the options.

When the user chooses to “update now,” the confirmation receiving part 164 receives a confirmation that the update is to be performed from the user. The EULA display part 166 next displays a EULA confirmation screen on the display of the second information processing device 12.

FIG. 6B shows an example of the EULA confirmation screen. The EULA confirmation screen displays the contents of the EULA included in the downloaded system software. The EULA display part 166 may download the EULA from the software server 14, or may download the EULA from a Web server retaining the EULA. When the user selects “accept,” the acceptance receiving part 168 receives a confirmation that the user has accepted the EULA.

When the acceptance receiving part 168 receives the acceptance confirmation, the update instruction generating part 170 generates an execution instruction to update the system software, and transmits the execution instruction via the communicating section 140. The update execution instruction in this case may directly instruct the first information processing device 10 to perform the update, or may be information indicating that the user has accepted the EULA. It suffices for the update execution instruction to be a trigger for the first information processing device 10 to perform the update. The update instruction generating part 170 transmits the update execution instruction to the notifying server 16.

In the notifying server 16, when the information receiving unit 192 receives the execution instruction to update the system software from the second information processing device 12, the notifying unit 194 immediately notifies the update execution instruction to the first information processing device 10. In the first information processing device 10, the update processing unit 124 obtains the software update execution instruction, and updates the system software. Thus, the user can update the system software of the first information processing device 10 from the place away from home, and start the latest system software on the first information processing device 10 after returning home.

Incidentally, when the user does not notice the notification from the first information processing device 10, or when the battery of the second information processing device 12 is dead, the user may not be able to respond to the notification from the first information processing device 10 immediately. In addition, when the user chooses to “update later” on the update confirmation screen shown in FIG. 6A, the update execution instruction is not transmitted from the second information processing device 12 to the first information processing device 10. The first information processing device 10 waits for the update execution instruction from the notifying server 16 after transmitting the information indicating that the system software is in an updatable state to the notifying server 16. During the waiting period, another user (for example a person living with the user) may turn on the main power supply of the first information processing device 10. When the main power supply of the first information processing device 10 is turned on, the first information processing device 10 displays a confirmation screen as shown in FIG. 6A on the output device 4. In this case, the other user may operate the input device 6 to choose “update now,” then accept the contents of the EULA, and complete updating the system software.

The first information processing device 10 in which the system update is completed at this time transmits, after a restart, information indicating that the updating of the system software has been completed to the notifying server 16. In the notifying server 16, when the information receiving unit 192 receives the information indicating that the software update has been completed from the first information processing device 10 before receiving the software update execution instruction from the second information processing device 12, the notifying unit 194 notifies the information indicating that the software update has been completed to the second information processing device 12. The user can therefore recognize that the first information processing device 10 is in the latest system state, that is, the system software is updated on the first information processing device 10, and thus does not need to start the updating application on the second information processing device 12.

Incidentally, before the information receiving unit 192 in the notifying server 16 receives the update execution instruction from the second information processing device 12, the other user (person living with the user) may turn on the main power supply of the first information processing device 10 and choose to “update later” on the update confirmation screen displayed on the output device 4. In this case, the other user plays a game without the system software being updated. During the play, the user may transmit the update execution instruction from the second information processing device 12, so that the information receiving unit 192 receives the update execution instruction and the notifying unit 194 transmits the update execution instruction to the first information processing device 10. In this case, the update processing unit 124 obtains the execution instruction, but does not perform the automatic update because an application is being executed. The update processing unit 124 may monitor a state of execution of the application on the first information processing device 10, and perform the automatic update at a point in time that the operation of the application is ended.

The present technology has been described above on the basis of an embodiment thereof. The present embodiment is illustrative, and it is to be understood by those skilled in the art that combinations of constituent elements and processing processes of the embodiment are susceptible of various modifications and that such modifications also fall within the scope of the present technology. In the embodiment, description has been made of the processing of updating the system software. However, application software may also be updated by a similar procedure.

In the embodiment, FIG. 6A is illustrated as an example of the update confirmation screen. However, the update confirmation screen may include text explaining conditions in the first information processing device 10. For example, when there is an application being executed on the first information processing device 10, text indicating a possibility that data of the application being executed may be lost when an system update is performed is preferably added as notes on the update confirmation screen shown in FIG. 6A.

The present technology contains subject matter related to that disclosed in Japanese Priority Patent Application JP 2014-120815 filed in the Japan Patent Office on Jun. 11, 2014, the entire contents of which are hereby incorporated by reference.

What is claimed is:

1. An information processing device comprising:
a notification processing unit notifying a user that a terminal device is in a state of being able to update software;
a confirmation receiving part receiving a confirmation that an update is to be performed from the user; and
a transmitting section transmitting an execution instruction to update the software.

2. The information processing device according to claim 1, wherein
the information processing device is a portable device.

3. The information processing device according to claim 1, further comprising
a first display section displaying, on a display, an option as to whether or not to update the software in the terminal device.

4. The information processing device according to claim 1, further comprising:
a second display section displaying contents of an end-user license agreement included in software downloaded to the terminal device; and
an acceptance receiving part receiving a confirmation that the user accepts the end-user license agreement;
when the acceptance receiving part receives the acceptance confirmation, the transmitting section transmitting the execution instruction to update the software.

5. An information processing system comprising:
a first information processing device; and
a second information processing device;
the first information processing device including
a download processing unit downloading software from a software server, and
an update processing unit updating software;
the second information processing device including
a notification processing unit notifying a user that the first information processing device is in a state of being able to update the software,
a confirmation receiving part receiving a confirmation that an update is to be performed from the user, and
a transmitting section transmitting an execution instruction to update the software;
when the update processing unit obtains the execution instruction to update the software, the update processing unit updating the software.

6. An information processing device comprising:
a download processing unit downloading software from a software server;
a determining unit referring to predetermined data included in the downloaded software, and determining whether or not user confirmation of a software update is necessary; and
an update processing unit transmitting information indicating that software is in an updatable state when the determining unit determines that the user confirmation is necessary;
when the update processing unit obtains an execution instruction to update the software, the execution instruction being input by a user on a terminal device, the update processing unit updating the software.
